(19) United States
(12) Patent Application Publication
(10) Pub. No.: US 2023/0053610 A1
(43) Pub. Date: Feb. 23, 2023

(54) Control Method for Banknote Accumulation Device, and Device and Cash Processing Apparatus

(71) Applicant: Shandong New Beiyang Information Technolgy Co., Ltd., Shandong (CN)

(72) Inventors: Zhuanlong Yu, Shandong (CN); Chuntao Wang, Shandong (CN)

(21) Appl. No.: 17/758,534

(22) PCT Filed: Jan. 12, 2021
(86) PCT No.: PCT/CN2021/071232

§ 371 Date: Jul. 8, 2022

(30) Foreign Application Priority Data
Jan. 15, 2020 (CN) 202010044146.1

(51) Int. Cl. G07D 11/235; G07D 11/125

(52) U.S. Cl. CPC G07D 11/235; G07D 11/125

(57) ABSTRACT

Provided are a method for controlling a banknote accumulation device, and a banknote accumulation device and a cash processing apparatus. The method includes: determining whether a banknote to enter a receiving cavity is an abnormal banknote; where the abnormal banknote is a banknote that meets any of the following: the tilt angle of the banknote exceeds a first preset value, the length of the banknote exceeds a second preset value, the banknote and another banknote are stuck together, the banknote overlaps another banknote, or the spacing between the banknote and an adjacent banknote is smaller than a third preset value; in response to determining that the banknote to enter the receiving cavity is the abnormal banknote, controlling a support plate to move to increase the height of the banknote accumulation space; and controlling a banknote conveying mechanism to convey the abnormal banknote into the receiving cavity.

The present disclosure claims priority to Chinese Patent Application No. 202010044146.1, filed with the China National Intellectual Property Administration (CNIPA) on Jan. 15, 2020, the disclosure of which is hereby incorporated by reference in its entirety.

### TECHNICAL FIELD

The present disclosure relates to the field of self-service financial equipment, for example, to a control method and device for a banknote accumulation device, and a cash processing apparatus.

### BACKGROUND

A cash processing apparatus includes a banknote-in device, a temporary storage device, a banknote-out device and at least one cash box, and the cash processing apparatus also includes a conveyance passage for causing the banknote-in device, the temporary storage device, the banknote-out device and the at least one cash box to be in communication with each other. Each of the temporary storage device, the banknote-out device or the at least one cash box has a receiving cavity for accumulating banknotes. A cash processing process includes the process in which banknotes enter and are accumulated in a receiving cavity of any of the above devices or the cash box. The related art discloses a cash processing apparatus, whose banknote-out device includes a receiving cavity for storing banknotes, a banknote conveying mechanism disposed at an inlet where the receiving cavity communicates with the conveyance passage, a support plate disposed in the receiving cavity and a support plate driving mechanism disposed in the receiving cavity. The support plate is configured to support banknotes in the receiving cavity, the banknote conveying mechanism is configured to drive banknotes in the conveyance passage one by one to pass from the inlet into the receiving cavity so that banknotes are sequentially stacked on the support plate, and the support plate driving mechanism is configured to drive the support plate to move along a direction in which banknotes are stacked. In order to cause banknotes to be neatly stacked in the receiving cavity during the process in which banknotes enter the receiving cavity (that is, a banknote accumulation process), a cash processing apparatus provided by the related art controls the movement of the support plate during the banknote accumulation process of the banknote-out device such that a height of banknote accumulation space in the receiving cavity is continuously maintained at a set value. However, as for the cash processing apparatus of the related art, when banknotes in the conveyance passage are in some abnormal states, the banknote-out device (or the temporary storage device or the cash box) can be blocked by banknotes at an inlet of the receiving cavity during the banknote accumulation process, resulting in the abnormal operating condition of the inability to continue to convey a banknote into the receiving cavity.

### SUMMARY

The present disclosure provides a control method and device for a banknote accumulation device, and a cash processing apparatus, which can improve the situation where banknotes easily block the inlet of a receiving cavity.

An embodiment of the present disclosure provides a method for controlling a banknote accumulation device. The banknote accumulation device includes a receiving cavity, a banknote conveying mechanism and a support plate driving mechanism. The receiving cavity includes a first opening, and the first opening is configured to receive a banknote to be accumulated into the receiving cavity. A support plate is movably disposed in the receiving cavity, and the support plate is configured to support banknotes. The banknote conveying mechanism is configured to drive a banknote to pass through the first opening into the receiving cavity so that banknotes are stacked on the support plate. The support plate driving mechanism is drivingly connected to the support plate and is configured to drive the support plate to move along a direction in which banknotes are stacked. The method includes: determining whether a banknote to enter the receiving cavity is an abnormal banknote, where the abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value; in response to determining that the banknote to enter the receiving cavity is the abnormal banknote, controlling the support plate to move to increase a height of banknote accumulation space; and controlling the banknote conveying mechanism to convey the abnormal banknote into the receiving cavity.

An embodiment of the present disclosure provides a control device for a banknote accumulation device. The banknote accumulation device includes a receiving cavity, a banknote conveying mechanism and a support plate driving mechanism. The receiving cavity includes a first opening, and the first opening is configured to receive a banknote to be accumulated into the receiving cavity. A support plate is movably disposed in the receiving cavity, and the support plate is configured to support banknotes. The banknote conveying mechanism is configured to drive a banknote to pass through the first opening into the receiving cavity so that banknotes are stacked on the support plate. The support plate driving mechanism is drivingly connected to the support plate and is configured to drive the support plate to move along a direction in which banknotes are stacked. The control device includes a determination module, adjustment module and a conveyance module.

The determination module is configured to determine whether a banknote to enter the receiving cavity is an abnormal banknote, where the abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value.

The adjustment module is configured to, in response to determining that the banknote to enter the receiving cavity is the abnormal banknote, control the support plate to move to increase a height of banknote accumulation space.

The conveyance module is configured to control the banknote conveying mechanism to convey the abnormal banknote into the receiving cavity.

An embodiment of the present disclosure provides a cash processing apparatus, including a controller, a banknote-in device, a temporary storage device, a banknote-out device, at least one cash box, and a conveyance passage which is configured to cause the banknote-in device, the temporary storage device, the banknote-out device and the at least one cash box to be in communication with each other. The controller is configured to execute executable programs to perform the method for controlling a banknote accumulation device according to the embodiment of the present disclosure. The banknote accumulation device is the temporary storage device, the banknote-out device or the at least one cash box.

An embodiment of the present disclosure provides a cash processing apparatus, including a controller, a banknote-in device, a temporary storage device, a banknote-out device, at least one cash box, and a conveyance passage which is configured to cause the banknote-in device, the temporary storage device, the banknote-out device and the at least one cash box to be in communication with each other. The controller is configured to execute executable programs to perform the method for controlling a banknote accumulation device according to the embodiment of the present disclosure. The banknote accumulation device is the temporary storage device or the banknote-out device. The banknote accumulation device further includes a second opening, the second opening is positioned downstream of a plurality of limiting members in a banknote-in direction, a gate is movably provided at the second opening, the banknote accumulation device further includes a gate driving mechanism, the gate driving mechanism is drivingly connected to the gate, the gate driving mechanism is configured to drive the gate to move to an open position which enables the second opening to be open or a closed position which enables the second opening to be closed, and the gate driving mechanism is electrically connected to the controller. The controller is further configured to: before controlling a limiting member driving mechanism to drive a limiting member located at an extended position to move to a retracted position, control the gate driving mechanism to drive the gate located at the open position to move to the closed position.

### BRIEF DESCRIPTION OF DRAWINGS

FIG. 1 is a structure view of a cash processing apparatus according to an embodiment of the present disclosure;

FIG. 2 is a structure view of a banknote accumulation device according to an embodiment of the present disclosure;

FIG. 3 is a block diagram of components of a cash processing apparatus according to an embodiment of the present disclosure;

FIG. 4 is a flowchart of a method for controlling a banknote accumulation device according to an embodiment of the present disclosure; and

FIG. 5 is a diagram of a control device for a banknote accumulation device according to an embodiment of the present disclosure.

Reference list:

| | |
|---|---|
| 10 cash processing apparatus | 221 first roller |
| 100 banknote-in device | 222 second roller |
| 200 temporary storage device | 223 third roller |
| 300 banknote-out device | 224 recessed region |
| 400 cash box | 230 support plate |
| 500 conveyance passage | 231 support plate driving |
| 600 banknote identification | mechanism |
| device | 232 first sensor |
| 700 detection component | 233 second sensor |
| 800 controller | 234 support surface |
| 20 banknote accumulation | 240 limiting member driving |
| device | mechanism |
| 210 frame body | 241 first limiting member |
| 211 receiving cavity | 242 second limiting member |
| 212 first opening | 243 third limiting member |
| 213 second opening | 250 guide plate |
| 214 gate | 31 determination module |
| 215 gate driving mechanism | 32 adjustment module |
| 220 banknote conveying | 33 conveyance module |
| mechanism | |

### DETAILED DESCRIPTION

In order to make objectives, technical solutions and advantages of embodiments of the present disclosure more clear, the technical solutions of the embodiments of the present disclosure will be clearly and completely described in conjunction with accompanying drawings in the embodiments of the present disclosure. Apparently, described embodiments are only part, but not all, of the embodiments of the present disclosure. The components of the embodiments of the present disclosure described and illustrated in the drawings herein generally may be arranged and designed in a variety of different configurations.

It should be noted that similar reference numerals and letters refer to similar items in the following figures, and if an item is defined in one figure, the item does not require further definition and explanation in subsequent figures.

In the description of the embodiments of the present disclosure, it should be noted that, if the terms “above”, “below”, “inside”, “outside” and the like are used, the orientational or positional relationships indicated by the terms are based on the orientational or positional relationships illustrated in the drawings, or are based on the orientational or positional relationships where a product is customarily placed when used, which are for the mere purpose of facilitating and simplifying the description of the present disclosure and do not indicate or imply that the device or element referred to has a specific orientation and is constructed and operated in a specific orientation, and thus it is not to be construed as limiting the present disclosure.

In addition, the terms “first”, “second” and the like when used are only used to distinguish descriptions and should not be construed as indicating or implying relative importance.

It should be noted that the features in the embodiments of the present disclosure may be combined mutually without conflict.

A cash processing apparatus provided by the related art includes a banknote-in device, a temporary storage device, a banknote-out device and at least one cash box. The cash processing apparatus also includes a conveyance passage for causing the banknote-in device, the temporary storage device, the banknote-out device and the at least one cash box to be in communication with each other, and a banknote identification device disposed in the conveyance passage. Each of the temporary storage device, the banknote-out device or the at least one cash box needs to have the function of storing banknotes. Therefore, a banknote accumulation device with a receiving cavity can be used as the temporary storage device, the banknote-out device or the cash box so that banknotes can accumulate in the receiving cavity. As for the cash processing apparatus in the related art, when banknotes in the conveyance passage are in some abnormal states, the banknote-out device can be blocked by banknotes at an inlet of the receiving cavity during a banknote accumulation process, resulting in the abnormal operating condition of the inability to continue to convey banknotes into the receiving cavity. After analysis, in the case where the tilt angle of banknotes conveyed in the conveyance passage is too large, or the length of the banknotes is too long since the banknotes are stuck together, or the banknotes overlap, or the spacing between adjacent banknotes is too small, when these abnormal banknotes enter the receiving cavity of the banknote-out device (or the temporary storage device, or the cash box), due to the limited height of banknote accumulation space, the banknotes may pile up to block the inlet of the receiving cavity during the process of entering the receiving cavity, resulting in the abnormal operating condition of the inability to continue to convey banknotes into the receiving cavity.

In order to improve the deficiency in the related art, the present disclosure provides a control method and device for a banknote accumulation device, and a cash processing apparatus to which the method for controlling a banknote accumulation device is applied. A cash processing apparatus and a banknote accumulation device provided by embodiments of the present disclosure are first introduced for the ease of understanding.

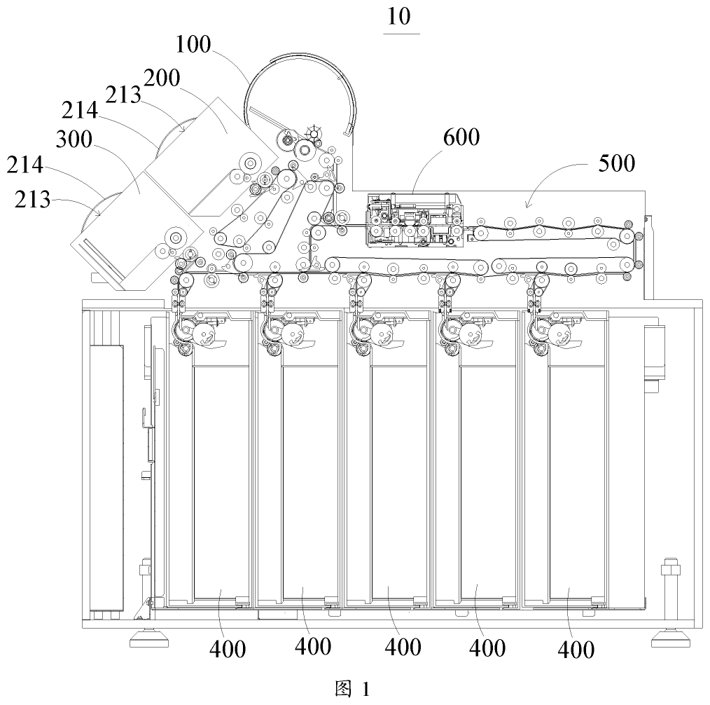

FIG. 1 is a structure view of a cash processing apparatus according to an embodiment of the present disclosure. Referring to FIG. 1, a cash processing apparatus 10 provided by the embodiment includes a controller 800 (referring to FIG. 3), a banknote-in device 100, a temporary storage device 200, a banknote-out device 300, at least one cash box 400, a conveyance passage 500 for causing the banknote-in device 100, the temporary storage device 200, the banknote-out device 300 and the at least one cash box 400 to be in communication with each other, and a banknote identification device 600 disposed in the conveyance passage 500.

The banknote-in device 100 can receive banknotes placed by a user and convey the banknotes placed by the user into the conveyance passage 500 one by one. The controller 800 conveys banknotes in the conveyance passage 500 into the temporary storage device 200, the banknote-out device 300 or the at least one cash box 400 according to the needs of the business process and the identification and detection state of the banknotes. The temporary storage device 200, the banknote-out device 300 and the at least one cash box 400 all can receive banknotes from the conveyance passage 500. For example, the banknote-out device 300 can receive banknotes conveyed from the banknote-in device 100, the temporary storage device 200 or the cash box 400 through the conveyance passage 500, and the received banknotes are presented to the user. Multiple detection components 700 (referring to FIG. 3) are arranged in the conveyance passage 500 of the cash processing apparatus 10 along a banknote conveying path. When a banknote is conveyed in the conveyance passage 500, the controller 800 detects a delivering state of the banknote through signals outputted by the multiple detection components 700, and records an abnormal state of the banknote when the banknote is abnormal, thereby determining whether the banknote is an abnormal banknote when the banknote is about to enter a receiving cavity of a corresponding device or cash box 400.

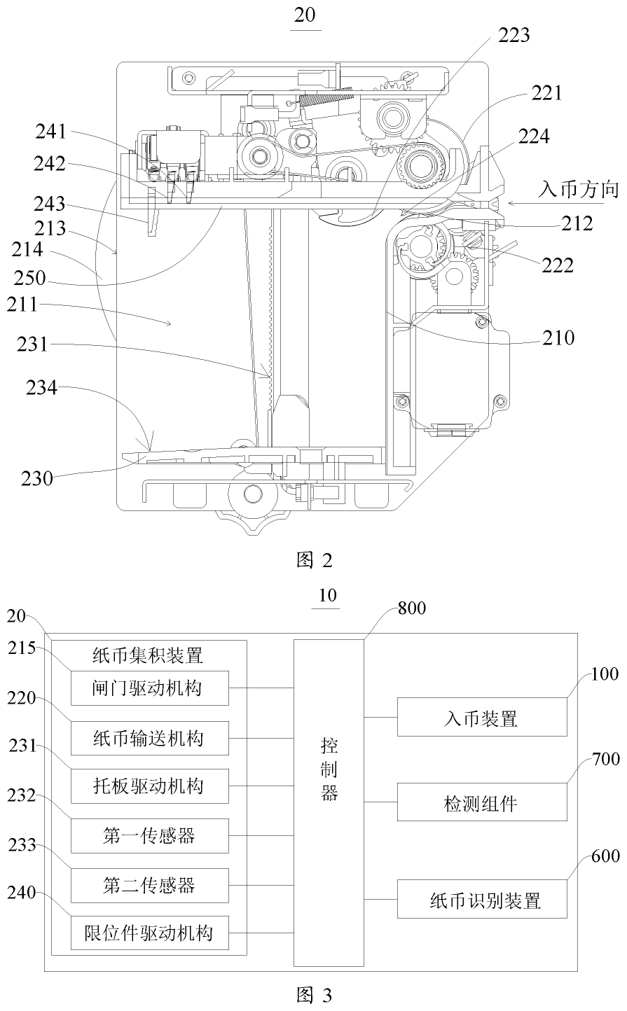

FIG. 2 is a structure view of a banknote accumulation device according to an embodiment of the present disclosure. Referring to FIG. 2 in conjunction with FIG. 1, a banknote accumulation device 20 provided by the embodiment of the present disclosure is configured to input and store banknotes. The banknote accumulation device 20 may be applied to a cash processing apparatus 10 provided by an embodiment of the present disclosure and is used as a temporary storage device 200, a banknote-out device 300 or a cash box 400. The temporary storage device 200, the banknote-out device 300 and each cash box 400 in the cash processing apparatus 10 shown in FIG. 1 each adopt the banknote accumulation device 20 in the embodiment illustrated in FIG. 2 of the present disclosure.

Referring to FIG. 2, the banknote accumulation device 20 includes a frame body 210, a banknote conveying mechanism 220 (referring to FIG. 3), a guide plate 250, a support plate 230 and a support plate driving mechanism 231. The frame body 210 forms a receiving cavity 211 for storing banknotes, and the banknotes can be stacked in the receiving cavity 211. The receiving cavity 211 has a first opening 212, and the first opening 212 is configured to receive banknotes to be accumulated in the receiving cavity 211. The support plate 230 is movably disposed in the receiving cavity 211, and the support plate 230 has a support surface 234 for supporting banknotes, and the banknotes can be stacked on the support surface 234 of the support plate 230. In the embodiment, the guide plate 250 is disposed opposite the support surface 234 of the support plate 230. The guide plate 250 is provided to guide a banknote which is entering the receiving cavity 211 from the first opening 212 to move along a banknote-in direction. The banknote-in direction is a moving direction of a banknote entering the receiving cavity 211 from the first opening 212. The space between the support surface 234 of the support plate 230 and the guide plate 250 is effective storage space for banknotes.

In the embodiment, driven by the support plate driving mechanism 231, the support plate 230 can approach or move away from the guide plate 250 to adjust the effective storage space for banknotes in the receiving cavity 211. The support plate driving mechanism 231 may include a stepping motor and a transmission mechanism which is composed of a gear and a rack, or a stepping motor and a transmission mechanism which is composed of a lead screw and a nut, as long as the support plate 230 can be driven to approach or move away from the guide plate 250.

In the process of using the banknote accumulation device 20, when banknotes are stacked in a receiving cavity 211, the support surface 234 of the support plate 230 is in contact with a surface of the innermost one of the stacked banknotes. For ease of description, during the banknote accumulation process, the support surface 234 opposite the guide plate 250, or a surface of the outermost one of the stacked banknotes (that is, one of the stacked banknotes which is farthest from the support surface 234) is referred to as a banknote accumulation surface, and banknote accumulation space for accumulating banknotes is formed between the banknote accumulation surface and the guide plate 250. When there are banknotes in the banknote accumulation space, the banknote accumulation surface is the surface of a banknote closest to the guide plate 250, and when there is no banknote in the banknote accumulation space, the banknote accumulation surface is the support surface 234 of the support plate 230. The height of the banknote accumulation space refers to the spacing between the banknote accumulation surface and the guide plate 250. The height of the banknote accumulation space reflects the ability of the receiving cavity 211 to receive banknotes.

In an embodiment, the banknote accumulation device 20 further includes a first sensor 232 (referring to FIG. 3) configured to detect whether the height of the banknote accumulation space is a preset value. When the height of the banknote accumulation space is smaller than the preset height, the first sensor 232 outputs a first signal, and when the height of the banknote accumulation space is greater than the preset height, the first sensor 232 outputs a second signal. Therefore, as the number of banknotes increases, the controller 800 of the cash processing apparatus 10 (referring to FIG. 3) can control the support plate 230 to gradually move away from the first opening 212 along a direction in which banknotes are stacked according to a signal outputted by the first sensor 232, so that the spacing between a banknote, closest to the guide plate 250, of the stacked banknotes and the guide plate 250 is continuously the preset height, that is, the height of the banknote accumulation space remains substantially unchanged.

In the embodiment, the support plate 230 has an initial position, and the initial position is a position of the support plate 230 in the receiving cavity 211 farthest from the first opening 212 along the direction in which the banknotes are stacked. Optionally, the banknote accumulation device 20 further includes a second sensor 233, and the second sensor 233 is configured to detect whether the support plate 230 is at the initial position. Thus, the second sensor 233 can feed back location information of the support plate 230 to the controller 800 of the cash processing apparatus 10. In the process of controlling the support plate 230 to move away from the first opening 212, the controller 800 can determine whether the support plate 230 reaches the initial position according to a detection signal outputted by the second sensor 233, and stops controlling the movement of the support plate 230 after determining that the support plate 230 reaches the initial position, avoiding the support plate driving mechanism 231 from being damaged.

The banknote conveying mechanism 220 is configured to drive banknotes to pass through the first opening 212 into the receiving cavity 211 so that the banknotes are stacked on the support plate 230. In an embodiment, the banknote conveying mechanism 220 includes a first roller 221 and a second roller 222 which are disposed opposite each other at the first opening 212, and a motor. There is a gap between the first roller 221 and the second roller 222, and when a banknote passes through the gap between the first roller 221 and the second roller 222, the banknote can be brought into the receiving cavity 211 by the first roller 221 and the second roller 222. The first roller 221 is drivingly connected to the motor, and the motor can drive the first roller 221 to rotate to drive banknotes to move into the receiving cavity 211. Referring to FIG. 2, the banknote conveying mechanism 220 may further include a third roller 223. The third roller 223 is positioned downstream of the first roller 221 in the banknote-in direction. When the support plate 230 is raised to a certain position, the outermost one of the banknotes stacked on the support plate 230 is in contact with the third roller 223, and the third roller 223 can rotate to drive the banknote in contact with the third roller 223 to move toward the first opening 212, thereby realizing outputting banknotes from the banknote accumulation device 20.

The banknote accumulation device 20 further includes multiple limiting members arranged in sequence along the banknote-in direction and a limiting member driving mechanism 240 (referring to FIG. 3), and the limiting member driving mechanism 240 is capable of driving each of the multiple limiting members to move to an extended position or a retracted position. When the limiting member is at the extended position, the limiting member extends to a movement path of a banknote moving in the receiving cavity 211 along the banknote-in direction, and when the limiting member is at the retracted position, the limiting member exits the movement path. When the limiting member is at the extended position, the limiting member can block corresponding banknotes from continuing to move along the banknote-in direction after the corresponding banknotes enter the receiving cavity 211. Since the multiple limiting members are arranged along the banknote-in direction, different limiting members have different distances from the first opening 212 and thus positions of different sizes of banknotes can be restricted by different limiting members, so that different sizes of banknotes can be stacked neatly after entering the receiving cavity 211. FIG. 2 illustrates a banknote accumulation device 20 including three limiting members. A first limiting member 241, a second limiting member 242 and a third limiting member 243 are arranged in sequence in the order of distance from the first opening 212 from near to far. The first limiting member 241 and the second limiting member 242 are located at the retracted position, and the third limiting member 243 is located at the extended position.

Optionally, when the banknote accumulation device 20 is applied to the cash processing apparatus 10 as the temporary storage device 200 or the banknote-out device 300, the receiving cavity 211 of the banknote accumulation device 20 further includes a second opening 213 disposed opposite the first opening 212, and the second opening 213 is positioned downstream of limiting members in the banknote-in direction. The banknote accumulation device 20 further includes a gate 214 movably disposed at the second opening 213 and a gate driving mechanism 215 configured to drive the gate 214 to move. The gate driving mechanism 215 is configured to drive the gate 214 to move to an open position which enables the second opening 213 to be open or a closed position which enables the second opening 213 to be closed. The second opening 213 can be used for banknotes to be fed out of the receiving cavity 211. The banknote accumulation device 20 with the second opening 213 is suitably used as the banknote-out device 300 or the temporary storage device 200 (as shown in FIG. 1). In other embodiments of the present disclosure, for example, when the banknote accumulation device 20 is used as a cash box 400, the banknote accumulation device 20 may not be provided with the second opening 213, the gate 214 and the gate driving mechanism 215.

FIG. 3 is a block diagram of components of the cash processing apparatus 10 according to the embodiment of the present disclosure. Referring to FIG. 3 in conjunction with the aforementioned drawings, in the embodiment, the support plate driving mechanism 231, the banknote conveying mechanism 220, the first sensor 232, the second sensor 233 and the limiting member driving mechanism 240 which are in a banknote accumulation device 20, the banknote-in device 100, the banknote identification device 600, and the detection components 700 are all electrically connected to the controller 800. The controller 800 is configured to: determine whether a banknote to enter the receiving cavity 211 is an abnormal banknote; in response to determining that the banknote to enter the receiving cavity 211 is the abnormal banknote, control the support plate 230 to move to increase the height of the banknote accumulation space; and control the banknote conveying mechanism 220 to convey the abnormal banknote into the receiving cavity 211. The abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value.

The cash processing apparatus 10 in the embodiment of the present disclosure is provided to, when a banknote to enter the receiving cavity 211 of the banknote accumulation device 20 is an abnormal banknote, control the support plate 230 to move to increase the height of the banknote accumulation space so that the receiving cavity 211 has enough space for banknotes to be transported when the abnormal banknote enters the banknote accumulation device 20, alleviating the pile-up of banknotes, avoiding the blockage of banknotes at an inlet of the receiving cavity 211 due to the pile-up of abnormal banknotes which results in the abnormal operating condition of the inability to continue to convey banknotes into the receiving cavity 211, and improving the operation stability of the cash processing apparatus 10.

Optionally, in response to determining that that the banknote to enter the receiving cavity 211 is the abnormal banknote, the controller 800 of the cash processing apparatus 10 controls the movement of the support plate 230 to increase the height of the banknote accumulation space by controlling the support plate 230 to move a set distance away from the first opening 212 along the direction in which banknotes are stacked, or controlling the support plate 230 to move to an initial position.

Optionally, the controller 800 is further configured to, after the abnormal banknote is conveyed into the receiving cavity 211, control the support plate 230 to move to a banknote receiving position so that the height of the banknote accumulation space in the receiving cavity 211 is a preset height. The banknote receiving position of the support plate 230 refers to a position which enables the height of the banknote accumulation space in the receiving cavity 211 to be the preset height, and the banknote receiving position of the support plate 230 varies with the height of the banknotes stacked on a support surface 234.

Optionally, the controller 800 is further configured to, in response to determining that the banknote to enter the receiving cavity 211 is the abnormal banknote, control the limiting member driving mechanism 240 to drive the limiting member located at the extended position to move to the retracted position.

Optionally, the controller 800 is further configured to, after the abnormal banknote enters the receiving cavity 211, control the limiting member driving mechanism 240 to drive a target limiting member to move to the extended position. Multiple limiting members correspond to different types of banknotes respectively, and the target limiting member is a limiting member corresponding to the next banknote to enter the receiving cavity 211.

Optionally, the controller 800 is further configured to: determine whether a banknote accumulation process is over; and in response to determining that the banknote accumulation process is over, control the motor of the banknote conveying mechanism 220 to drive the first roller 221 to rotate in a set direction and control the support plate 230 to move to the initial position. The set direction is a rotation direction of the first roller 221 capable of driving a banknote to move along the banknote-in direction.

Optionally, the controller 800 is further configured to: determine whether there is an abnormal banknote in the conveyance passage 500; in response to determining that there is an abnormal banknote in the conveyance passage 500, suspend conveying a banknote into the conveyance passage 500; and in response to determining that the abnormal banknote in the conveyance passage 500 is conveyed into the receiving cavity 211 of the banknote accumulation device 20, continue to convey a banknote into the conveyance passage 500.

Since banknotes entering the conveyance passage 500 will be conveyed into the receiving cavity 211 by the banknote conveying mechanism 220 of the banknote accumulation device 20, the conveyance of banknotes into the conveyance passage 500 is suspended when there is an abnormal banknote in the conveyance passage 500 so that the impact of the abnormal banknote on the conveyance of subsequent banknotes can be avoided and the operation stability of the cash processing apparatus 10 can be improved.

Optionally, when the temporary storage device 200 or the banknote-out device 300 adopts the banknote accumulation device 20 provided by the embodiments of the present disclosure, the gate driving mechanism 215 of the banknote accumulation device 20 is electrically connected to the controller 800 of the cash processing apparatus 10, and the controller 800 is further configured to: before the limiting member driving mechanism 240 is controlled to drive the limiting member located at the extended position to move toward the retracted position, control the gate driving mechanism 215 to drive the gate 214 located at the open position to move to the closed position.

A limiting member cannot block banknotes from moving along the banknote-in direction when the limiting member is at the retracted position. Therefore, before the limiting member moves to the retracted position, the gate driving mechanism 215 is first controlled to drive the gate 214 to close the second opening 213 so as to avoid the situation where banknotes to enter the receiving cavity 211 will fall out of the receiving cavity 211 via the second opening 213 after the limiting member moves to the retracted position.

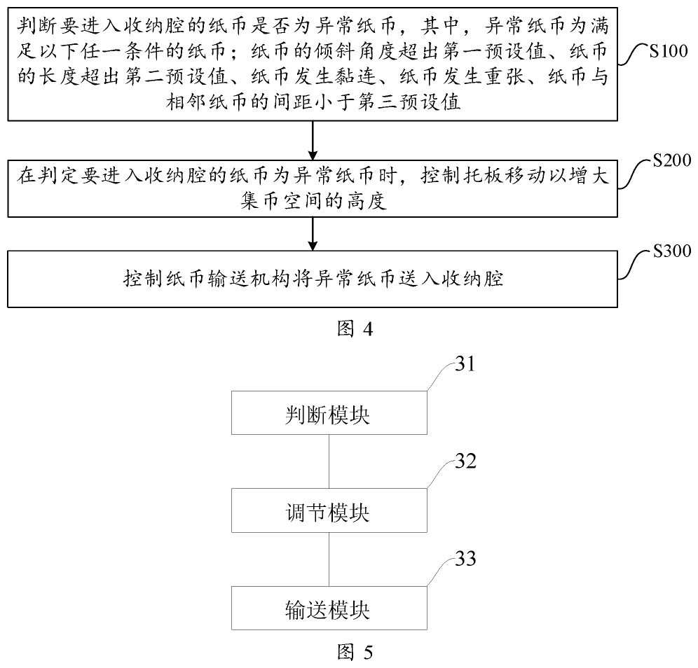

FIG. 4 is a flowchart of a method for controlling a banknote accumulation device according to an embodiment of the present disclosure. Referring to FIG. 4, the method for controlling a banknote accumulation device provided by embodiments of the present disclosure is applicable to the banknote accumulation device 20 of the cash processing apparatus 10 provided by the above embodiments of the present disclosure. The method for controlling a banknote accumulation device includes steps described below.

In S100, it is determined whether a banknote to enter a receiving cavity 211 is an abnormal banknote. The abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value.

Using the cash processing apparatus 10 provided in the embodiment of the present disclosure as an example, the controller 800 detects a delivering state of a banknote through signals outputted by the detection components 700 in the conveyance passage 500, and records an abnormal state of the banknote when the banknote is abnormal, thereby determining whether the banknote is an abnormal banknote when the banknote is about to enter the receiving cavity 211 of the banknote accumulation device 20. The cases that a tilt angle of the banknote is too large, a length of the banknote is too long, a spacing between the banknote and an adjacent banknote is too small, the banknote and another banknote are stuck together, the banknote overlaps another banknote all may result in abnormal deformation or blockage of the banknote at the first opening 212 when the banknote enters the receiving cavity 211. Thus, the banknote cannot fall to the banknote accumulation surface properly to achieve the accumulation. Therefore, such abnormal banknote is detected before entering the receiving cavity 211.

In S200, in response to determining that the banknote to enter the receiving cavity is the abnormal banknote, the support plate 230 is controlled to move to increase the height of the banknote accumulation space.

Using the cash processing apparatus 10 provided in the embodiments of the present disclosure as an example, in response to determining that the banknote to enter the receiving cavity 211 is the abnormal banknote, the controller 800 controls the support plate 230 to move to increase the height of the banknote accumulation space. Exemplarily, the controller 800 may be configured to control the support plate 230 to move a set distance away from the first opening 212 along the direction in which banknotes are stacked, that is, to control the support plate 230 to move a set distance away from the guide plate 250, which can be achieved, for example, by controlling a stepping motor of the support plate driving mechanism 231 to rotate by a set angle. Alternatively, the controller 800 may also control the support plate driving mechanism 231 to drive the support plate 230 to move to an initial position. The initial position is a position of the support plate 230 in the receiving cavity 211 farthest from the first opening 212 along the direction in which banknotes are stacked. In the process of driving the support plate 230 by the support plate driving mechanism 231 to move toward the initial position, the controller 800 can detect, by the second sensor 233, whether the support plate 230 reaches the initial position. when detecting that the support plate 230 reaches the initial position by the second sensor 233, the controller 800 controls the support plate driving mechanism 231 to stop driving the movement of the support plate 230.

In S300, the banknote conveying mechanism 220 is controlled to convey the abnormal banknote into the receiving cavity 211.

Using the cash processing apparatus 10 provided in the embodiments of the present disclosure as an example, after controlling the support plate 230 to move to increase the height of the banknote accumulation space, the controller 800 controls the motor of the banknote conveying mechanism 220 to drive the first roller 221 to rotate so as to convey the abnormal banknote into the receiving cavity 211.

The method for controlling a banknote accumulation device provided by the embodiment can control, when a banknote to enter the receiving cavity 211 of the banknote accumulation device 20 is an abnormal banknote, the support plate 230 to move to increase the height of the banknote accumulation space so that the receiving cavity 211 has enough space for banknotes to be conveyed when the abnormal banknote enters the banknote accumulation device 20, alleviating the pile-up of banknotes, avoiding the blockage of banknotes at the inlet of the receiving cavity 211 due to the pile-up of abnormal banknotes which results in the abnormal operating condition of the inability to continue to convey banknotes into the receiving cavity 211, and improving the operation stability of the cash processing apparatus 10.

In an embodiment, before controlling the banknote conveying mechanism 220 to convey the abnormal banknote into the receiving cavity 211, the method for controlling a banknote accumulation device may further include: in response to determining that the banknote to enter the receiving cavity 211 is the abnormal banknote, controlling the limiting member driving mechanism 240 to drive a limiting member located at an extended position to move to a retracted position. In this manner, all limiting members can be placed at the retracted position when the banknote is abnormal so that the size of banknote accumulation space can be increased along the banknote-in direction, alleviating the pile-up of banknotes, avoiding the blockage of banknotes at the inlet of the receiving cavity 211, and avoiding the abnormal operating condition of the inability to continue to convey banknotes into the receiving cavity 211 due to the pile-up of banknotes.

The banknote accumulation device 20 shown in FIGS. 2 and 3 has the second opening 213, the gate 214 and the gate driving mechanism 215, and thus before the banknote conveying mechanism 220 is controlled to convey the abnormal banknote into the receiving cavity 211, the method for controlling a banknote accumulation device may further include: before the limiting member driving mechanism 240 is controlled to drive the limiting member located at the extended position to move to the retracted position, controlling the gate driving mechanism 215 to drive the gate 214 located at an open position to move to a closed position. With the second opening 213 closed, it can be ensured that banknotes will not fall out of the banknote accumulation device 20 through the second opening 213 when all the limiting members are at the retracted position.

Optionally, after the abnormal banknote is conveyed into the receiving cavity 211, the method for controlling a banknote accumulation device may further include: controlling the limiting member driving mechanism 240 to drive a target limiting member to move to an extended position. Multiple limiting members correspond to different types of banknotes respectively, and the target limiting member is a limiting member corresponding to the next banknote to enter the receiving cavity 211. After the abnormal banknote is conveyed into the receiving cavity 211, the target limiting member is driven to move to the extended position to ensure the accumulation and storage of subsequent normal banknotes, that is, it is ensured by the limiting member that the next normal banknote can be neatly stacked on the banknote accumulation surface.

Optionally, after controlling the banknote conveying mechanism 220 to convey the abnormal banknote into the receiving cavity 211, the method for controlling a banknote accumulation device may further include: determining whether a banknote accumulation process is over; and in response to determining that the banknote accumulation process is over, controlling a motor of the banknote conveying mechanism 220 to drive the first roller 221 to rotate in a set direction and controlling the support plate 230 to move to the initial position. The set direction is a rotation direction of the first roller 221 capable of driving a banknote to move along the banknote-in direction. In an embodiment, the controller 800 determines whether all the banknotes involved in the current banknote business process are accumulated into the receiving cavity 211, and if all the banknotes involved in the current banknote business process are accumulated into the receiving cavity 211, the controller 800 determines that the banknote accumulation process is over, and if not all the banknotes involved in the current banknote business process are accumulated into the receiving cavity 211, the controller 800 determines that the banknote accumulation process is not over. The banknote business process may be a deposit process, a withdrawal process, a sorting process, an inventory process, or like. In response to determining that the banknote accumulation process is over, the controller 800 controls the support plate driving mechanism 231 to drive the support plate 230 to the initial position. The controller 800 may first control the motor to start driving the first roller 221 to rotate in the set direction and then control the support plate 230 to start moving to the initial position, or the controller 800 may control the motor to start driving the first roller 221 to rotate along in the set direction and control the support plate 230 to start moving to the initial position at the same time, or the controller 800 may first control the support plate 230 to start moving to the initial position and then immediately control the motor to start driving the first roller 221 to rotate in the set direction. With the motor controlled to rotate by a set angle in a set direction during the movement of the support plate 230, the first roller 221 and the second roller 222 can be rotated in a set direction to provide a driving force for banknotes to move in the banknote-in direction in the case where there is a banknote in a recessed region 224 formed by the first roller 221 and the second roller 222, which can prevent the abnormality of the banknote when the support plate 230 is moved to the initial position in the case where a tail of the banknote enters the recessed area 224 formed by the first roller 221 and the second roller 222. In an embodiment, the motor may be controlled to stop driving the first roller 221 to rotate after the first roller 221 rotates by a set angle along the set direction, or the motor may be controlled to stop driving the first roller 221 to rotate when the support plate 230 moves to the initial position.

In the embodiment, to ensure that banknotes can be neatly stacked on the support plate 230, the position of the support plate 230 is controlled to change with the number of banknotes in the process of the accumulation of normal banknotes, thereby ensuring that the height of the banknote accumulation space is substantially unchanged to be a preset height. Exemplarily, the controller 800 determines the height of the banknote accumulation space according to a signal outputted by the first sensor 232. When the height of the banknote accumulation space is smaller than the preset height as banknotes continuously accumulates, the first sensor 232 outputs a first signal. The controller 800 controls the support plate 230 to move away from the first opening 212 according to the first signal, and stops when the first sensor 232 outputs a second signal, so that in the normal accumulation process, the height of the banknote accumulation space is always kept at the preset height.

After the abnormal banknote is conveyed into the receiving cavity 211, the method for controlling a banknote accumulation device may further include: controlling the support plate 230 to move to a banknote receiving position so that the height of the banknote accumulation space in the receiving cavity 211 is the preset height. On the basis of the above embodiments, the height of the banknote accumulation space in the process of conveying the abnormal banknote into the receiving cavity 211 is greater than the height of the banknote accumulation space during the normal accumulation process. After the abnormal banknote is accumulated, the controller 800 re-controls the support plate 230 to move to restore the height of the banknote accumulation space to the preset height, ensuring the accumulation of subsequent normal banknotes.

FIG. 5 is a diagram of a control device for a banknote accumulation device according to an embodiment of the present disclosure. Referring to FIG. 5, an embodiment of the present disclosure further provides a control device of a banknote accumulation device, which can be configured to implement the method for controlling a banknote accumulation device according to the embodiments of the present disclosure. The control device may be integrated in the controller 800 in FIG. 3, and the control device includes a determination module 31, an adjustment module 32 and a conveyance module 33.

The determination module 31 is configured to determine whether a banknote to enter a receiving cavity 211 is an abnormal banknote, where the abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value.

The adjustment module 32 is configured to, in response to determining that the banknote to enter the receiving cavity 211 is the abnormal banknote, control the support plate 230 to move to increase the height of the banknote accumulation space.

The conveyance module 33 is configured to, after the adjustment module 32 controls the support plate 230 to move to increase the height of the banknote accumulation space, control the banknote conveying mechanism 220 to convey the abnormal banknote into the receiving cavity 211.

It should be understood that the above modules all are executable software modules and computer programs, and the specific implementation of their corresponding functions in terms of methods can refer to the method for controlling a banknote accumulation device provided by embodiments of the present disclosure and will not be repeated here. The control device of a banknote accumulation device provided by embodiments of the present disclosure may further include more functional modules to perform other control steps in the above control methods.

What is claimed is:

1. A method for controlling a banknote accumulation device, the banknote accumulation device comprising a receiving cavity, a banknote conveying mechanism and a support plate driving mechanism, wherein the receiving cavity comprises a first opening configured to receive banknotes to be accumulated into the receiving cavity, a support plate is movably disposed in the receiving cavity to support banknotes; the banknote conveying mechanism is configured to drive banknotes to pass through the first opening into the receiving cavity so that the banknotes are stacked on the support plate; and the support plate driving mechanism is drivingly connected to the support plate and is configured to drive the support plate to move along a direction in which the banknotes are stacked, the method comprising:
determining whether a banknote to enter the receiving cavity is an abnormal banknote, wherein the abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value;
in response to determining that the banknote to enter the receiving cavity is the abnormal banknote, controlling the support plate to move to increase a height of banknote accumulation space; and
controlling the banknote conveying mechanism to convey the abnormal banknote into the receiving cavity.

2. The method for controlling the banknote accumulation device according to claim 1, wherein in response to determining that the banknote to enter the receiving cavity is the abnormal banknote, controlling the support plate to move to increase the height of the banknote accumulation space comprises:
in response to determining that the banknote to enter the receiving cavity is the abnormal banknote, controlling the support plate to move a set distance away from the first opening along the direction in which the banknotes are stacked; or
in response to determining that the banknote to enter the receiving cavity is the abnormal banknote, controlling the support plate to move to an initial position, wherein the initial position is a position of the support plate in the receiving cavity farthest from the first opening along the direction in which the banknotes are stacked.

3. The method for controlling the banknote accumulation device according to claim 1, further comprising:
after the abnormal banknote is conveyed into the receiving cavity, controlling the support plate to move to a banknote receiving position so that the height of the banknote accumulation space in the receiving cavity is a preset height.

4. The method for controlling the banknote accumulation device according to claim 1, wherein the banknote accumulation device further comprises a plurality of limiting members arranged in sequence along a banknote-in direction and a limiting member driving mechanism, wherein the limiting member driving mechanism is capable of driving each of the plurality limiting members to move to an extended position or a retracted position, wherein the banknote-in direction is a moving direction of a banknote entering the receiving cavity from the first opening, when the each of the plurality limiting members is at the extended position, the each of the plurality limiting members extends to a movement path of a banknote moving in the receiving cavity along the banknote-in direction, and when the each of the plurality limiting members is at the retracted position, the each of the plurality limiting members exits the movement path, the method further comprising:
in response to determining that the banknote to enter the receiving cavity is the abnormal banknote, controlling the limiting member driving mechanism to drive the each of the plurality limiting members located at the extended position to move to the retracted position.

5. The method for controlling the banknote accumulation device according to claim 4, further comprising:
after the abnormal banknote is conveyed into the receiving cavity, controlling the limiting member driving mechanism to drive a target limiting member to move to an extended position, wherein the plurality of limiting members of the banknote accumulation device correspond to different types of banknotes respectively, and the target limiting member is one of the plurality of limiting members corresponding to a next banknote to enter the receiving cavity.

6. The method for controlling the banknote accumulation device according to claim 1, wherein the banknote conveying mechanism comprises a first roller and a second roller disposed opposite each other at the first opening, and a motor drivingly connected to the first roller, the method further comprising:
determining whether a banknote accumulation process is over; and
in response to determining that the banknote accumulation process is over, controlling the motor to drive the first roller to rotate in a set direction and controlling the support plate to move to an initial position, wherein the set direction is a rotation direction of the first roller capable of driving a banknote to move along a banknote-in direction, the banknote-in direction is a moving direction of a banknote entering the receiving cavity from the first opening, and the initial position is a position of the support plate in the receiving cavity farthest from the first opening along the direction in which the banknotes are stacked.

7. A control device for a banknote accumulation device, the banknote accumulation device comprising a receiving cavity, a banknote conveying mechanism and a support plate driving mechanism, wherein the receiving cavity comprises a first opening, the first opening is configured to receive a banknote to be accumulated into the receiving cavity, a support plate is movably disposed in the receiving cavity to support banknotes; the banknote conveying mechanism is configured to drive banknotes to pass through the first opening into the receiving cavity so that the banknotes are stacked on the support plate; and the support plate driving mechanism is drivingly connected to the support plate and is configured to drive the support plate to move along a direction in which the banknotes are stacked, the control device comprising:
a determination module configured to determine whether a banknote to enter the receiving cavity is an abnormal banknote, wherein the abnormal banknote is a banknote that meets any one of the following conditions: a tilt angle of the banknote exceeds a first preset value, a length of the banknote exceeds a second preset value, the banknote and another banknote are stuck together, the banknote overlaps another banknote, or a spacing between the banknote and an adjacent banknote is smaller than a third preset value;
an adjustment module configured to, in response to determining that the banknote to enter the receiving cavity is the abnormal banknote, control the support plate to move to increase a height of banknote accumulation space; and
a conveyance module configured to, after the adjustment module controls the support plate to move to increase the height of the banknote accumulation space, control the banknote conveying mechanism to convey the abnormal banknote into the receiving cavity.

8. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 1, wherein the banknote accumulation device is the temporary storage device, the banknote-out device or the at least one cash box.

9. The cash processing apparatus according to claim 8, wherein the controller is further configured to:
determine whether there is an abnormal banknote in the conveyance passage;
in response to determining that there is an abnormal banknote in the conveyance passage, suspend conveying a banknote into the conveyance passage; and
in response to determining that the abnormal banknote in the conveyance passage is conveyed into the receiving cavity of the banknote accumulation device, continue to convey a banknote into the conveyance passage.

10. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 4, wherein the banknote accumulation device is the temporary storage device or the banknote-out device, wherein the banknote accumulation device further comprises a second opening, the second opening is positioned downstream of the plurality of limiting members in the banknote-in direction, a gate is movably provided at the second opening, the banknote accumulation device further comprises a gate driving mechanism drivingly connected to the gate the gate driving mechanism is configured to drive the gate to move to an open position which enables the second opening to be open or a closed position which enables the second opening to be closed, and the gate driving mechanism is electrically connected to the controller, the controller is further configured to:
before controlling the limiting member driving mechanism to drive each of the plurality limiting members located at the extended position to move toward the retracted position, control the gate driving mechanism to drive the gate located at the open position to move to the closed position.

11. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 2, wherein the banknote accumulation device is the temporary storage device, the banknote-out device or the at least one cash box.

12. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 3, wherein the banknote accumulation device is the temporary storage device, the banknote-out device or the at least one cash box.

13. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 4, wherein the banknote accumulation device is the temporary storage device, the banknote-out device or the at least one cash box.

14. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 5, wherein the banknote accumulation device is the temporary storage device, the banknote-out device or the at least one cash box.

15. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling the banknote accumulation device according to claim 6, wherein the banknote accumulation device is the temporary storage device, the banknote-out device or the at least one cash box.

16. A cash processing apparatus, comprising a controller, a banknote-in device, a temporary storage device, a banknote-out device, at least one cash box and a conveyance passage which is configured to cause the banknote-in device, the temporary storage device, the banknote-out device and the at least one cash box to be in communication with each other, wherein the controller is configured to execute executable programs to perform the method for controlling a banknote accumulation device according to claim 5, wherein the banknote accumulation device is the temporary storage device or the banknote-out device, wherein the banknote accumulation device further comprises a second opening, the second opening is positioned downstream of the plurality of limiting members in the banknote-in direction, a gate is movably provided at the second opening, the banknote accumulation device further comprises a gate driving mechanism drivingly connected to the gate, the gate driving mechanism is configured to drive the gate to move to an open position which enables the second opening to be open or a closed position which enables the second opening to be closed, and the gate driving mechanism is electrically connected to the controller, the controller is further configured to:
before controlling the limiting member driving mechanism to drive each of the plurality limiting members located at the extended position to move toward the retracted position, control the gate driving mechanism to drive the gate located at the open position to move to the closed position.
